(19) United States
(12) Patent Application Publication
(10) Pub. No.: US 2019/0266668 A1
(43) Pub. Date: Aug. 29, 2019

(54) REGULATORY COMPLIANCE SYSTEM AND METHOD

(71) Applicant: WEALTH WIZARDS LIMITED, Leamington SPa (GB)

(72) Inventor: Tony VAIL, Leamington Spa (GB)

(21) Appl. No.: 16/344,894

(22) PCT Filed: Oct. 25, 2017
(86) PCT No.: PCT/GB2017/053217

§ 371 Date: Apr. 25, 2019

(30) Foreign Application Priority Data
Oct. 25, 2016 (GB) 1618026.7
Jul. 31, 2017 (GB) 1712261.5

(51) Int. Cl. G06Q 40/02; G06Q 30/00

(52) U.S. Cl. CPC G06Q 40/02; G06Q 40/06; G06Q 30/018

(57) ABSTRACT

A server system for providing financial advice, wherein the system is configured to: receive financial advice rules changes thereto to produce a set of updated financial advice rules; run test cases using the updated financial advice rules to produce and output test case results, to test that the updated financial advice rules have been correctly implemented; receive a confirmation in respect of the outputted test case results which indicates that the outputted test case results complies with a corporate certification standard; output financial advice questions, and to receive user input in response to the financial advice questions; use the corporate certification standard-approved set of updated financial advice rules to generate responses to the user input which was received in response to the financial advice questions, and output the responses to the user input which was received in response to the financial advice questions.

### BACKGROUND OF THE INVENTION

### 1. Field of the Invention

The field of the invention relates to systems and methods for providing financial advice, wherein the financial advice satisfies a corporate certification standard, and provides a system and method suitable for verifying regulatory compliance related to provision of computer-generated financial advice.

### 2. Technical Background

A 2013 Organisation for Economic Co-operation and Development (OECD) study entitled “Financial literacy and inclusion” found worryingly low levels of financial literacy around the world. Of particular concern was the relatively large proportion of people who could not calculate simple interest earned on a savings account at the end of one year and then identify the impact of compounding over 5 years. In Albania and Peru, fewer than 1 in 5 people were able to apply their knowledge to this two-part question, and in every country except Norway, at least half of the population failed to identify the impact of compounding. There was also a worryingly low level of awareness of the benefit of diversification, with at least a third and in some cases over half of respondents in each country being unable to answer this question. In all countries, people who were aware of at least 5 financial products had higher levels of financial literacy than those who were less aware. In some countries, low levels of financial knowledge were associated with low levels of financial product awareness, suggesting that financial education policies could usefully provide general financial knowledge whilst also improving awareness of financial products. The positive association between financial inclusion and financial literacy suggests an important role for financial education in the drive to increase levels of inclusion in some countries. Moreover, the various indicators of financial inclusion are significantly associated with various socio-demographic factors such as gender, age, education, and household income; suggesting that targeted financial education may reap the highest rewards.

3. Discussion of Related Art

In the United Kingdom, financial ignorance is rife. 4 in 5 people have no idea how they will fund their retirement. 2 in 3 financial products are bought without advice. 1 in 5 people cannot read a bank statement. 16 Million adults are in an advice gap. Similar problems may exist in other countries.

Although there are many factors behind the financial ignorance of people, such as poor maths skills, and unfamiliarity with financial terms such as “net”, “gross”, and “annual percentage rate of charge (APR)”, one issue is the lack of ease with which financial advice can be accessed. The ease with which financial advice can be accessed relates to cost (financial advisers are unlikely to be cost effective for smaller investments), but also to connectivity (a financial adviser may be relatively unwilling to talk to you on a weekday at 9 pm when you finally secure some free time to think about financial planning strategy). Finally, there are regulatory issues, because complying with regulations costs money, and leads to risks for financial advisers if regulatory requirements are not followed rigorously e.g fines or imprisonment. Hence in the current regulatory environment, by the time a financial adviser has complied with the regulations, the cost he must charge for his services will deter many of the users who would benefit from his services. Although some financial advice can be obtained from websites, there are risks to the providers of such advice in terms of regulatory compliance, which means that the available advice tends to be for relatively simple, straightforward comparisons. And for example a website may just list available financial products, such as for example a list of available rates for fixed rate interest rates on a home loan, and leave the user to decide which product provides the best rate in the list.

Regulatory compliance is more complex than simply being able to comply with financial advice regulations at one point in time. The financial environment changes quite frequently over time. For example, a taxation regime may change one or twice per year, or more frequently. Interest rates, commodity prices and stock market indices may change even more frequently. It is a challenge to maintain up-to-date regulatory compliance in a dynamic financial environment. It may be possible to provide a technical solution to this problem, in the context of providing computer-generated financial advice. A technical problem is to provide a technical system which facilitates financial advice regulatory compliance, in the context of providing computer-generated financial advice.

What is needed is a technical solution which facilitates financial advice regulatory compliance in a dynamically changing financial environment, while enabling financial advice to be provided up to 24 hours per day, to a user using a connected communication device that is in communication with the provider of the financial advice. Such a technical solution would have the benefit of enabling more people to obtain suitable financial advice, at a suitable cost, and at a suitable time, which has the potential to be of enormous benefit to society, in the United Kingdom, and in other countries.

EP1450923(B1) discloses an electronic regulatory compliance system and method that permits a regulatory agency to efficiently and accurately monitor thousands of environmental equipment installations, such as homeowner wastewater treatment plants, for compliance with regulatory requirements. The environmental equipment installations may be installed at different locations, operating on different inspection schedules, with different service companies, different owners, of different types, and be of a different processing capacity. A personnel detector is preferably utilized to verify the actual physical presence of service personnel. In the disclosure, each environmental equipment system is connected to a network that logs and time-stamps events that occurs at each of the plurality of environmental equipment systems related to compliance with environmental regulations. In a preferred embodiment, a website is generated that permits a regulatory body to quickly view all accounts in noncompliance and automatically generate suitable notices of noncompliance for transmission to responsible parties.

### SUMMARY OF THE INVENTION

According to a first aspect of the invention, there is provided a server system for providing financial advice, wherein the financial advice satisfies a corporate certification standard, the server system including a processor, the server system being one in which:

(i) the system is configured to receive a set of financial advice rules, and to receive changes to the set of financial advice rules, such as changes in taxation rules, to produce a set of updated financial advice rules;

(ii) the system is configured to include a set of test cases;

(iii) the system is configured to run the test cases using the set of updated financial advice rules to produce a set of test case results, to test that the updated financial advice rules have been correctly implemented, and to output the set of test case results, in which the outputted set of test case results is suitable for corporate compliance and governance oversight;

(iv) the system is configured to receive a confirmation in respect of the outputted set of test case results which indicates that the outputted set of test case results complies with a corporate certification standard;

(v) the system is configured to output financial advice questions, and to receive user input in response to the financial advice questions;

(vi) the system is configured to use the corporate certification standard-approved set of updated financial advice rules, approved in part (iv), to generate responses to the user input which was received in response to the financial advice questions, and

(vii) the system is configured to output the responses to the user input which was received in response to the financial advice questions.

The server system has the advantage that the system runs the test cases using the set of updated financial advice rules to produce a set of test case results, to test that the updated financial advice rules have been correctly implemented, and to output the set of test case results, in which the outputted set of test case results is suitable for corporate compliance and governance oversight. The system is therefore suitable for meeting regulatory standards for the provision of financial advice, because confirmation may be received in respect of the outputted set of test case results which indicates that the outputted set of test case results complies with a corporate certification standard. Such confirmation may be logged and inspected, in a suitably configured system, which therefore makes the system suitable for meeting regulatory standards for the provision of financial advice.

The server system has the further advantage that it is suitable for providing regulated financial advice to users who would otherwise be unable to afford the financial advice. The server system has the further advantage that it can provide regulated financial advice to users in a more convenient way, such as at night or in the evenings, or at weekends. The server system has the further advantage that it operates more reliably and reproducibly, in the provision of financial advice.

The server system may be configured to store the set of financial advice rules, and to store the set of updated financial advice rules. An advantage is that the server system is suitable for providing regulated financial advice to users.

The server system may be configured to store the set of test cases. An advantage is that the server system is suitable for providing regulated financial advice to users.

The server system may be configured to store the set of test case results. An advantage is that the server system is suitable for providing regulated financial advice to users.

The server system may be configured to provide a stored set of test case results, in response to a request for the stored set of test case results. An advantage is that the server system is suitable for providing regulated financial advice to users.

The server system may be configured to store the confirmation which indicates that the outputted set of test case results complies with a corporate certification standard. An advantage is that the server system is suitable for providing regulated financial advice to users.

The server system may be configured to provide a stored confirmation which indicates that the outputted set of test case results complies with a corporate certification standard, in response to a request for the stored confirmation which indicates that the outputted set of test case results complies with a corporate certification standard. An advantage is that the server system is suitable for providing regulated financial advice to users.

The server system may be configured to receive and to store the financial advice questions. An advantage is that the server system is suitable for providing regulated financial advice to users.

The server system may be configured to store the received user input in response to the financial advice questions. An advantage is that the server system is suitable for providing regulated financial advice to users.

The server system may be configured to store the generated responses to the user input which was received in response to the financial advice questions. An advantage is that the server system is suitable for providing regulated financial advice to users.

The server system may be configured to store the outputted responses to the user input which was received in response to the financial advice questions. An advantage that the server system is suitable for providing regulated financial advice to users.

The server system may be one wherein the output responses to the user input is in the form of a communication to the user.

The server system may be one wherein the communication is a letter-like communication.

An advantage is that the output is in a format that is familiar to any user.

The server system may be one wherein the communication is to a smart phone, a tablet computer, a laptop computer, a desktop computer, or to a TV computer. An advantage is that the financial advice can be accessed by a wide selection of users.

The server system may be one wherein the system includes servicing and governance components.

The server system may be one wherein the servicing and governance components provide visibility and control over tracking customer interactions and/or employee workflow related to the financial advice.

The server system may be one wherein the servicing and governance components provide record keeping to a standard appropriate to the provision of regulated financial advice.

The server system may be one wherein the servicing and governance components provide access to evidence that any change to the system has been adequately tested.

The server system may be one wherein the servicing and governance components provide access to Robo-tester evidence.

The server system may be one wherein the financial advice includes one or more of:

pension advice, retirement advice, investment advice, paraplanner output, defined benefit (DB) pensions transfer advice, protection advice, debt advice, equity release advice or mortgage advice.

The server system may be one wherein the server is a single server in a single location, a group of servers in a single location, a group of servers over multiple locations, a virtual server over many locations, or a virtual server in the Cloud.

The server system may be one wherein the server system is distributed across multiple zones and regions.

The server system may be one wherein the server system includes an internet gateway and a virtual private network gateway.

The server system may be one wherein the server system achieves resiliency and scalability through its use of clustering with Docker containers and Kubernetes scheduling.

The server system may be one in which the server stores data, wherein the data stored on the server is in a mix of Structured Query Language (SQL) and No-SQL databases, and S3 object buckets.

The server system may be one wherein the server system includes a range of security mechanisms including one or more of: network segmentation, firewalls, multiple levels of encryption and public key cryptography.

The server system may be one wherein the server system includes a micro-services architecture.

The server system may be one wherein the server system is integrate-able with existing internal or third party systems through APIs. The server system may have its own APIs to allow internal or third parties to integrate with it, and/or the server system may integrate with APIs on existing internal or third party systems.

According to a second aspect of the invention, there is provided a computer-implemented method for providing regulatory-compliant financial advice, wherein the financial advice satisfies a corporate certification standard, the method including the steps of:

(i) receiving a set of financial advice rules, and receiving changes to the set of financial advice rules, such as changes in taxation rules, to produce a set of updated financial advice rules;

(ii) accessing a set of test cases;

(iii) running the test cases using the set of updated financial advice rules to produce a set of test case results, to test that the updated financial advice rules have been correctly implemented, and outputting the set of test case results, in which the outputted set of test case results is suitable for corporate compliance and governance oversight;

(iv) receiving a confirmation in respect of the outputted set of test case results which indicates that the outputted set of test case results complies with a corporate certification standard;

(v) outputting financial advice questions, and receiving user input in response to the financial advice questions;

(vi) using the corporate certification standard-approved set of updated financial advice rules, approved in step (iv), to generate responses to the user input which was received in response to the financial advice questions, and

(vii) outputting the responses to the user input which was received in response to the financial advice questions.

The method may be one which is executed on a system of any aspect according to the first aspect of the invention.

According to a third aspect of the invention, there is provided a computer program product for providing regulatory-compliant financial advice, wherein the financial advice satisfies a corporate certification standard, the computer program product executable on a processor to:

(i) receive a set of financial advice rules, and to receive changes to the set of financial advice rules, such as changes in taxation rules, to produce a set of updated financial advice rules;

(ii) access a set of test cases;

(iii) run the test cases using the set of updated financial advice rules to produce a set of test case results, to test that the updated financial advice rules have been correctly implemented, and to output the set of test case results, in which the outputted set of test case results is suitable for corporate compliance and governance oversight;

(iv) receive a confirmation in respect of the outputted set of test case results which indicates that the outputted set of test case results complies with a corporate certification standard;

(v) output financial advice questions, and receive user input in response to the financial advice questions;

(vi) use the corporate certification standard-approved set of updated financial advice rules, approved in part (iv), to generate responses to the user input which was received in response to the financial advice questions, and

(vii) output the responses to the user input which was received in response to the financial advice questions.

The computer program product may be one which is arranged to be executable on a system of any aspect according to the first aspect of the invention.

According to a fourth aspect of the invention, there is provided a computer for providing financial advice, wherein the financial advice satisfies a corporate certification standard, the computer including a processor, the computer being one such that:

(i) the computer is configured to receive a set of financial advice rules, and to receive changes to the set of financial advice rules, such as changes in taxation rules, to produce a set of updated financial advice rules;

(ii) the computer is configured to include a set of test cases;

(iii) the computer is configured to run the test cases using the set of updated financial advice rules to produce a set of test case results, to test that the updated financial advice rules have been correctly implemented, and to output the set of test case results, in which the outputted set of test case results is suitable for corporate compliance and governance oversight;

(iv) the computer is configured to receive a confirmation in respect of the outputted set of test case results which indicates that the outputted set of test case results complies with a corporate certification standard;

(v) the computer is configured to output financial advice questions, and to receive user input in response to the financial advice questions;

(vi) the computer is configured to use the corporate certification standard-approved set of updated financial advice rules, approved in part (iv), to generate responses to the user input which was received in response to the financial advice questions, and

(vii) the computer is configured to output the responses to the user input which was received in response to the financial advice questions.

The computer may be one which is arranged according to any aspect according to the first aspect of the invention.

### BRIEF DESCRIPTION OF THE FIGURES

Aspects of the invention will now be described, by way of example(s), with reference to the following Figures, in which:

FIG. 1 shows a user advice example. This is an example of a letter-like communication.

FIG. 2 shows a user advice example. This is an example of a letter-like communication.

FIG. 3 shows a user advice example. This is an example of a letter-like communication.

FIG. 4 shows an example Smart Platform Infrastructure stack.

FIG. 5 shows an overview of the business of Wealth Wizards.

FIG. 6 shows examples of financial products which sit on the Wealth Wizards Smart Platform.

FIG. 7 shows how Roboadvice may sit between customers, providers and the Market. ‘FAMR’ stands for Financial Advice Market Review. ‘DC’ stands for direct contributions.

FIG. 8 shows an example of a platform architecture. ‘UX’ stands for user experience.

FIG. 9 shows two example Adviser Journeys.

### DETAILED DESCRIPTION

There is provided a server system for providing financial advice, wherein the financial advice satisfies a corporate certification standard, in which:

(i) the system is configured to receive a set of financial advice rules, and to receive changes to the set of financial advice rules, such as changes in taxation rules, to produce a set of updated financial advice rules;

(ii) the system is configured to include a set of test cases;

(iii) the system is configured to run the test cases using the set of updated financial advice rules to produce a set of test case results, to test that the updated financial advice rules have been correctly implemented, and to output the set of test case results, in which the outputted set of test case results is suitable for corporate compliance and governance oversight;

(iv) the system is configured to receive a confirmation in respect of the outputted set of test case results which indicates that the outputted set of test case results comply with a corporate certification standard;

(v) the system is configured to output financial advice questions, and to receive user input in response to the financial advice questions;

(vi) the system is configured to use the corporate certification standard-approved set of updated financial advice rules, approved in part (iv), to generate responses to the user input which was received in response to the financial advice questions, and

(vii) the system is configured to output the responses to the user input which was received in response to the financial advice questions.

In this disclosure, a “server” should be construed broadly to include examples such as a single server in a single location, a group of servers in a single location, a group of servers over multiple locations, or a virtual server over many locations or in the Cloud, as would be clear to one skilled in the art.

To illustrate examples of aspects of the invention, we provide below four example sets of Financial Advice Rules, in which the second, third and fourth sets of rules include a change with respect to one of the sets of Financial Advice Rules. It should be noted that in a typical implementation, a full set of Financial Advice Rules will be significantly more complex than is provided in these examples, which are provided to aid in understanding aspects of the invention.

### First Example Set of Financial Advice Rules

Triage Rules:

1) If {A1=Yes} and {A2=Advice} and {A3=Yes} and {A4=Yes} then client can proceed to the advice service, otherwise display/communicate message “You are not eligible for this advice service”.

At-Retirement Advice Rules

1 If {A6=Certainty} then Product advice=“Guaranteed annuity”

2 If {A9=No} then Product advice=“Guaranteed annuity”

3 If {A10=No} then Product advice=“Guaranteed annuity”

4 If {A6=Flexibility} and {A9=Yes} and {A10=Yes} then Product advice=“Drawdown”

5 The income level advice is determined by the following priority order of needs:
highest—meeting target standard of living {A1} or as high as possible if below, then providing for dependents if {A8=Dependents}, then providing increasing income if {A7=lower intial}

6 If Product advice=“Guaranteed annuity” and {A3=No} then using the table “Guaranteed annuity rates/Normal Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Normal health | Increasing | Level | Increasing | Level |
| Male 65+ | 4.75% | 5.25% | 5.75% | 6.25% |
| Male under 65 | 4.25% | 4.75% | 5.25% | 5.75% |
| Female 65+ | 3.75% | 4.25% | 4.75% | 5.25% |
| Female under 65 | 3.25% | 3.75% | 4.25% | 4.75% |

7 If Product advice=“Guaranteed annuity” and {A3=Yes} then using the table “Guaranteed annuity rates/Poor Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Poor health | Increasing | Level | Increasing | Level |
| Male 65+ | 5.00% | 5.50% | 6.00% | 6.50% |
| Male under 65 | 4.50% | 5.00% | 5.50% | 6.00% |
| Female 65+ | 4.00% | 4.50% | 5.00% | 5.50% |
| Female under 65 | 3.50% | 4.00% | 4.50% | 5.00% |

8 If Product advice=“Drawdown” then using the table “Maximum drawdown rates” select optimal rate based on age {A4} and gender (A5} that meets priority order of needs

| Maximum | Targeting inheritance in | | Not targeting inheritance in | |
|---|---|---|---|---|
| drawdown | 30 years | | 30 years | |
| rates | Increasing | Level | Increasing | Level |
| Male 65+ | 5.00% | 5.50% | 6.00% | 6.50% |
| Male under 65 | 4.50% | 5.00% | 5.50% | 6.00% |
| Female 65+ | 4.00% | 4.50% | 5.00% | 5.50% |
| Female under 65 | 3.50% | 4.00% | 4.50% | 5.00% |

9 Income recommendation={A2}×Selected rate

10 Review income=“Every year on anniversary of retirement”

### Second Example Set of Financial Advice Rules

Triage Rules

1) If {A1=Yes} and {A2=Advice} and {A3=Yes} and {A4=Yes} then client can proceed to the advice service, otherwise display/communicate message “You are not eligible for this advice service”

At-Retirement Advice Rules

(Change compared to First Example set of Financial Advice Rules: Maximum drawdown and annuity rates decrease in the Tables under rules 6, 7 and 8)

1 If {A6=Certainty} then Product advice=“Guaranteed annuity”

2 If {A9=No} then Product advice=“Guaranteed annuity”

3 If {A10=No} then Product advice=“Guaranteed annuity”

4 If {A6=Flexibility} and {A9=Yes} and {A10=Yes} then Product advice=“Drawdown”

5 The income level advice is determined by the following priority order of needs:
highest—meeting target standard of living {A1} or as high as possible if below, then providing for dependents if {A8=Dependents}, then providing increasing income if {A7=lower intial}

6 If Product advice=“Guaranteed annuity” and {A3=No} then using the table “Guaranteed annuity rates/Normal Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Normal health | Increasing | Level | Increasing | Level |
| Male 65+ | 4.25% | 4.75% | 5.25% | 5.75% |
| Male under 65 | 3.75% | 4.25% | 4.75% | 5.25% |
| Female 65+ | 3.25% | 3.75% | 4.25% | 4.75% |
| Female under 65 | 2.75% | 3.25% | 3.75% | 4.25% |

7 If Product advice=“Guaranteed annuity” and {A3=Yes} then using the table “Guaranteed annuity rates/Poor Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Poor health | Increasing | Level | Increasing | Level |
| Male 65+ | 4.50% | 5.00% | 5.50% | 6.00% |
| Male under 65 | 4.00% | 4.50% | 5.00% | 5.50% |
| Female 65+ | 3.50% | 4.00% | 4.50% | 5.00% |
| Female under 65 | 3.00% | 3.50% | 4.00% | 4.50% |

8 If Product advice=“Drawdown” then using the table “Maximum drawdown rates” select optimal rate based on age {A4} and gender (A5} that meets priority order of needs

| Maximum | Targeting inheritance in | | Not targeting inheritance in | |
|---|---|---|---|---|
| drawdown | 30 years | | 30 years | |
| rates | Increasing | Level | Increasing | Level |
| Male 65+ | 4.50% | 5.00% | 5.50% | 6.00% |
| Male under 65 | 4.00% | 4.50% | 5.00% | 5.50% |
| Female 65+ | 3.50% | 4.00% | 4.50% | 5.00% |
| Female under 65 | 3.00% | 3.50% | 4.00% | 4.50% |

### Third Example Set of Financial Advice Rules

Triage Rules

1) If {A1=Yes} and {A2=Advice} and {A3=Yes} and {A4=Yes} then client can proceed to the advice service, otherwise display/communicate message “You are not eligible for this advice service”

At-Retirement Advice Rules

(Change compared to Second Example set of Financial Advice Rules: Priority for determining income changes: see rule 5)

1 If {A6=Certainty} then Product advice=“Guaranteed annuity”

2 If {A9=No} then Product advice=“Guaranteed annuity”

3 If {A10=No} then Product advice=“Guaranteed annuity”

4 If {A6=Flexibility} and {A9=Yes} and {A10=Yes} then Product advice=“Drawdown”

5 The income level advice is determined by the following priority order of needs:
highest—meeting target standard of living {A1} or as high as possible if below, then providing increasing income if {A7=lower intial}, then providing for dependents if {A8=Dependents}

6 If Product advice=“Guaranteed annuity” and {A3=No} then using the table “Guaranteed annuity rates/Normal Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Normal health | Increasing | Level | Increasing | Level |
| Male 65+ | 4.25% | 4.75% | 5.25% | 5.75% |
| Male under 65 | 3.75% | 4.25% | 4.75% | 5.25% |
| Female 65+ | 3.25% | 3.75% | 4.25% | 4.75% |
| Female under 65 | 2.75% | 3.25% | 3.75% | 4.25% |

7 If Product advice=“Guaranteed annuity” and {A3=Yes} then using the table “Guaranteed annuity rates/Poor Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Poor health | Increasing | Level | Increasing | Level |
| Male 65+ | 4.50% | 5.00% | 5.50% | 6.00% |
| Male under 65 | 4.00% | 4.50% | 5.00% | 5.50% |
| Female 65+ | 3.50% | 4.00% | 4.50% | 5.00% |
| Female under 65 | 3.00% | 3.50% | 4.00% | 4.50% |

8 If Product advice=“Drawdown” then using the table “Maximum drawdown rates” select optimal rate based on age {A4} and gender (A5} that meets priority order of needs

| Maximum | Targeting inheritance in | | Not targeting inheritance in | |
|---|---|---|---|---|
| drawdown | 30 years | | 30 years | |
| rates | Increasing | Level | Increasing | Level |
| Male 65+ | 4.50% | 5.00% | 5.50% | 6.00% |
| Male under 65 | 4.00% | 4.50% | 5.00% | 5.50% |
| Female 65+ | 3.50% | 4.00% | 4.50% | 5.00% |
| Female under 65 | 3.00% | 3.50% | 4.00% | 4.50% |

9 Income recommendation={A2}×Selected rate

10 Review income=“Every year on anniversary of retirement”

### Fourth Example Set of Financial Advice Rules

Triage Rules

1) If {A1=Yes} and {A2=Advice} and {A3=Yes} and {A4=Yes} then client can proceed to the advice service, otherwise display/communicate message “You are not eligible for this advice service”

At-Retirement Advice Rules

(Change compared to Third Example set of Financial Advice Rules: frequency of income review has changed: see rule 10)

1 If {A6=Certainty} then Product advice=“Guaranteed annuity”

2 If {A9=No} then Product advice=“Guaranteed annuity”

3 If {A10=No} then Product advice=“Guaranteed annuity”

4 If {A6=Flexibility} and {A9=Yes} and {A10=Yes} then Product advice=“Drawdown”

5 The income level advice is determined by the following priority order of needs:
highest—meeting target standard of living {A1} or as high as possible if below, then providing increasing income if {A7=lower intial}, then providing for dependents if {A8=Dependents}

6 If Product advice=“Guaranteed annuity” and {A3=No} then using the table “Guaranteed annuity rates/Normal Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Normal health | Increasing | Level | Increasing | Level |
| Male 65+ | 4.25% | 4.75% | 5.25% | 5.75% |
| Male under 65 | 3.75% | 4.25% | 4.75% | 5.25% |
| Female 65+ | 3.25% | 3.75% | 4.25% | 4.75% |
| Female under 65 | 2.75% | 3.25% | 3.75% | 4.25% |

7 If Product advice=“Guaranteed annuity” and {A3=Yes} then using the table “Guaranteed annuity rates/Poor Health” select optimal rate based on age {A4} and gender (A5} that meets priority order of needs

| Guaranteed | With dependents benefit | | No dependents benefit | |
|---|---|---|---|---|
| income rates | paid on death | | paid on death | |
| Poor health | Increasing | Level | Increasing | Level |
| Male 65+ | 4.50% | 5.00% | 5.50% | 6.00% |
| Male under 65 | 4.00% | 4.50% | 5.00% | 5.50% |
| Female 65+ | 3.50% | 4.00% | 4.50% | 5.00% |
| Female under 65 | 3.00% | 3.50% | 4.00% | 4.50% |

8 If Product advice=“Drawdown” then using the table “Maximum drawdown rates” select optimal rate based on age {A4} and gender (A5} that meets priority order of needs

| Maximum | Targeting inheritance in | | Not targeting inheritance in | |
|---|---|---|---|---|
| drawdown | 30 years | | 30 years | |
| rates | Increasing | Level | Increasing | Level |
| Male 65+ | 4.50% | 5.00% | 5.50% | 6.00% |
| Male under 65 | 4.00% | 4.50% | 5.00% | 5.50% |
| Female 65+ | 3.50% | 4.00% | 4.50% | 5.00% |
| Female under 65 | 3.00% | 3.50% | 4.00% | 4.50% |

9 Income recommendation={A2}×Selected rate

10 Review income=“Every 6 months after retirement”

The following Test Case examples are provided.

### Test Case Example One

Chosen selections are indicated in bold.

| | At retirement advice - | | |
|---|---|---|---|
| | Triage questions | | |
| 1 | Are you a UK resident? | Yes | No |
| 2 | Do you want to receive a | Advice | Decide Myself |
| | personal recommendation | | |
| | approved by an adviser | | |
| | for which there will be a | | |
| | fee on completion, or do | | |
| | you want to decide | | |
| | yourself? | | |
| 3 | Are your pension pots | Yes | No |
| | worth more than | | |
| | £30,000 in total? | | |
| 4 | Do you agree with the | Yes | No |
| | terms of business for XYZ | | |
| | advisers Ltd advice | | |
| | services? | | |
| | (Termsofbusiness.pdf | | |
| | link) | | |

| | At-retirement advice - | | |
|---|---|---|---|
| | Fact find questions | | |
| 1 | How much do you need | £10,000 | Range £0+ |
| | each year from your | | |
| | pensions under advice to | | |
| | meet your target | | |
| | standard of living in | | |
| | retirement? | | |
| 2 | How much are your | £200,000 | Range >£30,000 |
| | available pension pots | | |
| | worth? | | |
| 3 | Do you have a doctor's | Yes | No |
| | report to show your | | |
| | health is poor enough to | | |
| | affect your life | | |
| | expectancy? | | |
| 4 | What is your age? | 67 | Range 55+ |
| 5 | What is your gender? | Male | Female |
| 6 | Do you prefer certainty | Certainty | Flexibility |
| | of income of flexibility of | | |
| | income in retirement? | | |
| 7 | Do you prefer higher | Higher initial | Lower initial |
| | initial income or lower | | |
| | initial income that will | | |
| | increase every year? | | |
| 8 | Do you prefer to provide | Yourself | Dependents |
| | for dependents or use | | |
| | the pension pots all for | | |
| | yourself? | | |
| 9 | Can you find other | Yes | No |
| | sources of income if your | | |
| | retirement income fell | | |
| | below what is needed? | | |
| 10 | Are you willing to take | Yes | No |
| | investment risk for the | | |
| | chance of increasing your | | |
| | retirement income? | | |

| | At-retirement advice - | | |
|---|---|---|---|
| | Fact find questions - | | |
| | Confirmation | | |
| 1 | I confirm that the | Yes | No |
| | information I have | | |
| | provided is accurate and | | |
| | that I agree with all | | |
| | statements displayed | | |
| | that relate to my answers | | |

In the following four tables, an expected change in advice output is indicated in bold.

Advice rules - First Set (A)
Solution Summary

| | |
|---|---|
| Triage determined user eligible for advice: | Yes |
| Confirmation accurate information and | Yes |
| agreement with statements: | |
| Product recommendation: | Drawdown |
| Income recommendation: | £10,000 |
| Dependents benefits recommendation: | Targeting inheritance in 30 |
| | years |
| Increasing or level income recommendation: | Increasing |
| Review frequency: | Annual |

Advice rules - Second Set (B)
Solution Summary

| | |
|---|---|
| Triage determined user eligible for advice: | Yes |
| Confirmation accurate information and | Yes |
| agreement with statements: | |
| Product recommendation: | Drawdown |
| Income recommendation: | £10,000 |
| Dependents benefits recommendation: | Targeting inheritance in 30 |
| | years |
| Increasing or level income recommendation: | Level income |
| Review frequency: | Annual |

Advice rules - Third Set (C)
Solution Summary

| | |
|---|---|
| Triage determined user eligible for advice: | Yes |
| Confirmation accurate information and | Yes |
| agreement with statements: | |
| Product recommendation: | Drawdown |
| Income recommendation: | £10,000 |
| Dependents benefits recommendation: | Not targeting inheritance in |
| | 30 years |
| Increasing or level income recommendation: | Increasing |
| Review frequency: | Annual |

Advice rules - Fourth Set (D)
Solution Summary

| | |
|---|---|
| Triage determined user eligible for advice: | Yes |
| Confirmation accurate information and | Yes |
| agreement with statements: | |
| Product recommendation: | Drawdown |
| Income recommendation: | £10,000 |
| Dependents benefits recommendation: | Not targeting inheritance in |
| | 30 years |
| Increasing or level income | Increasing |
| recommendation: | |
| Review frequency: | Six monthly |

### Test Case Example Two

Chosen selections are indicated in bold.

| | At retirement advice - | | |
|---|---|---|---|
| | Triage questions | | |
| 1 | Are you a UK resident? | Yes | No |
| 2 | Do you want to receive a | Advice | Decide Myself |
| | personal recommendation | | |
| | approved by an adviser | | |
| | for which there will be a | | |
| | fee on completion, or do | | |
| | you want to decide | | |
| | yourself? | | |
| 3 | Are your pension pots | Yes | No |
| | worth more than | | |
| | £30,000 in total? | | |
| 4 | Do you agree with the | Yes | No |
| | terms of business for XYZ | | |
| | advisers Ltd advice | | |
| | services ? | | |
| | (Termsofbusiness.pdf | | |
| | link) | | |

| | At-retirement advice - | | |
|---|---|---|---|
| | Fact find questions | | |
| 1 | How much do you need | £3,250 | Range £0+ |
| | each year from your | | |
| | pensions under advice to | | |
| | meet your target | | |
| | standard of living in | | |
| | retirement? | | |
| 2 | How much are your | £100,000 | Range >£30,000 |
| | available pension pots | | |
| | worth? | | |
| 3 | Do you have a doctor's | Yes | No |
| | report to show your | | |
| | health is poor enough to | | |
| | affect your life | | |
| | expectancy? | | |
| 4 | What is your age? | 62 | Range 55+ |
| 5 | What is your gender? | Male | Female |
| 6 | Do you prefer certainty | Certainty | Flexibility |
| | of income of flexibility of | | |
| | income in retirement? | | |
| 7 | Do you prefer higher | Higher initial | Lower initial |
| | initial income or lower | | |
| | initial income that will | | |
| | increase every year? | | |
| 8 | Do you prefer to provide | Yourself | Dependents |
| | for dependents or use | | |
| | the pension pots all for | | |
| | yourself? | | |
| 9 | Can you find other | Yes | No |
| | sources of income if your | | |
| | retirement income fell | | |
| | below what is needed? | | |
| 10 | Are you willing to take | Yes | No |
| | investment risk for the | | |
| | chance of increasing your | | |
| | retirement income? | | |

| | At-retirement advice - | | |
|---|---|---|---|
| | Fact find questions - | | |
| | Confirmation | | |
| 1 | I confirm that the | Yes | No |
| | information I have | | |
| | provided is accurate and | | |
| | that I agree with all | | |
| | statements displayed | | |
| | that relate to my answers | | |

In the following four tables, an expected change in advice output is indicated in bold.

Advice rules - First Set (A)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/normal |
| | health |
| Income recommendation: | £3,250 |
| Dependents benefits recommendation: | Targeting inheritance in |
| | 30 years |
| Increasing or level income | Increasing income |
| recommendation: | |
| Review frequency: | Annual |

Advice rules - Second Set (B)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/normal |
| | health |
| Income recommendation: | £3,250 |
| Dependents benefits recommendation: | Targeting inheritance in |
| | 30 years |
| Increasing or level income | Level income |
| recommendation: | |
| Review frequency: | Annual |

Advice rules - Third Set (C )
Solution Summary

| | |
|---|---|
| Triage determined user eligible | Yes |
| for advice: | |
| Confirmation accurate information | Yes |
| and agreement with statements: | |
| Product recommendation: | Guaranteed annuity/normal |
| | health |
| Income recommendation: | £3,250 |
| Dependents benefits recommendation: | Not targeting inheritance in |
| | 30 years |
| Increasing or level income | Increasing income |
| recommendation: | |
| Review frequency: | Annual |

Advice rules - Fourth Set (D)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/normal |
| | health |
| Income recommendation: | £3,250 |
| Dependents benefits recommendation: | Not targeting inheritance in |
| | 30 years |
| Increasing or level income | Increasing |
| recommendation: | |
| Review frequency: | Six monthly |

### Test Case Example Three

Chosen selections are indicated in bold.

| | At retirement advice - | | |
|---|---|---|---|
| | Triage questions | | |
| 1 | Are you a UK resident? | Yes | No |
| 2 | Do you want to receive a | Advice | Decide Myself |
| | personal | | |
| | recommendation | | |
| | approved by an adviser | | |
| | for which there will be a | | |
| | fee on completion, or do | | |
| | you want to decide | | |
| | yourself? | | |
| 3 | Are your pension pots | Yes | No |
| | worth more than | | |
| | £30,000 in total? | | |
| 4 | Do you agree with the | Yes | No |
| | terms of business for XYZ | | |
| | advisers Ltd advice | | |
| | services ? | | |
| | (Termsofbusiness.pdf | | |
| | link) | | |

| | At-retirement advice - | | |
|---|---|---|---|
| | Fact find questions | | |
| 1 | How much do you need | £6,000 | Range £0+ |
| | each year from your | | |
| | pensions under advice to | | |
| | meet your target | | |
| | standard of living in | | |
| | retirement? | | |
| 2 | How much are your | £100,000 | Range >£30,000 |
| | available pension pots | | |
| | worth? | | |
| 3 | Do you have a doctor's | Yes | No |
| | report to show your | | |
| | health is poor enough to | | |
| | affect your life | | |
| | expectancy? | | |
| 4 | What is your age? | 61 | Range 55+ |
| 5 | What is your gender? | Male | Female |
| 6 | Do you prefer certainty | Certainty | Flexibility |
| | of income of flexibility of | | |
| | income in retirement? | | |
| 7 | Do you prefer higher | Higher initial | Lower initial |
| | initial income or lower | | |
| | initial income that will | | |
| | increase every year? | | |
| 8 | Do you prefer to provide | Yourself | Dependents |
| | for dependents or use | | |
| | the pension pots all for | | |
| | yourself? | | |
| 9 | Can you find other | Yes | No |
| | sources of income if your | | |
| | retirement income fell | | |
| | below what is needed? | | |
| 10 | Are you willing to take | Yes | No |
| | investment risk for the | | |
| | chance of increasing your | | |
| | retirement income? | | |

| | At-retirement advice - | | |
|---|---|---|---|
| | Fact find questions - | | |
| | Confirmation | | |
| 1 | I confirm that the | Yes | No |
| | information I have | | |
| | provided is accurate and | | |
| | that I agree with all | | |
| | statements displayed | | |
| | that relate to my answers | | |

In the following four tables, an expected change in advice output is indicated in bold.

Advice rules - First Set (A)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/poor |
| | health |
| Income recommendation: | £6,000 |
| Dependents benefits recommendation: | Not targeting inheritance in |
| | 30 years |
| Increasing or level income | Higher initial |
| recommendation: | |
| Review frequency: | Annual |

Advice rules - Second Set (B)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/poor |
| | health |
| Income recommendation: | £5,500 |
| Dependents benefits recommendation: | Not targeting inheritance in |
| | 30 years |
| Increasing or level income | Higher initial |
| recommendation: | |
| Review frequency: | Annual |

Advice rules - Third Set (C)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/poor |
| | health |
| Income recommendation: | £5,500 |
| Dependents benefits recommendation: | Not targeting inheritance in |
| | 30 years |
| Increasing or level income | Higher initial |
| recommendation: | |
| Review frequency: | Annual |

Advice rules - Fourth Set (D)
Solution Summary

| | |
|---|---|
| Triage determined user eligible | Yes |
| for advice: | |
| Confirmation accurate information | Yes |
| and agreement with statements: | |
| Product recommendation: | Guaranteed annuity/poor |
| | health |
| Income recommendation: | £5,500 |
| Dependents benefits recommendation: | Not targeting inheritance in |
| | 30 years |
| Increasing or level income | Higher initial |
| recommendation: | |
| Review frequency: | Six monthly |

Test Cases Results Summary

Test case results summary

| System release | A | B | C | D |
|---|---|---|---|---|
| Test case 1 | Match to 1A | Match to 1B | Match to 1C | Match to 1D |
| Test case 2 | Match to 2A | Match to 2B | Match to 2C | Match to 2D |
| Test case 3 | Match to 3A | Match to 3B | Match to 3C | Match to 3D |

For a set of three test cases, and four system releases (or four differing sets of Financial Advice Rules), the above table summarizes a set of test case results which may be generated, and/or stored, using an example system of the invention.

### Test Case 1A—User Advice Example

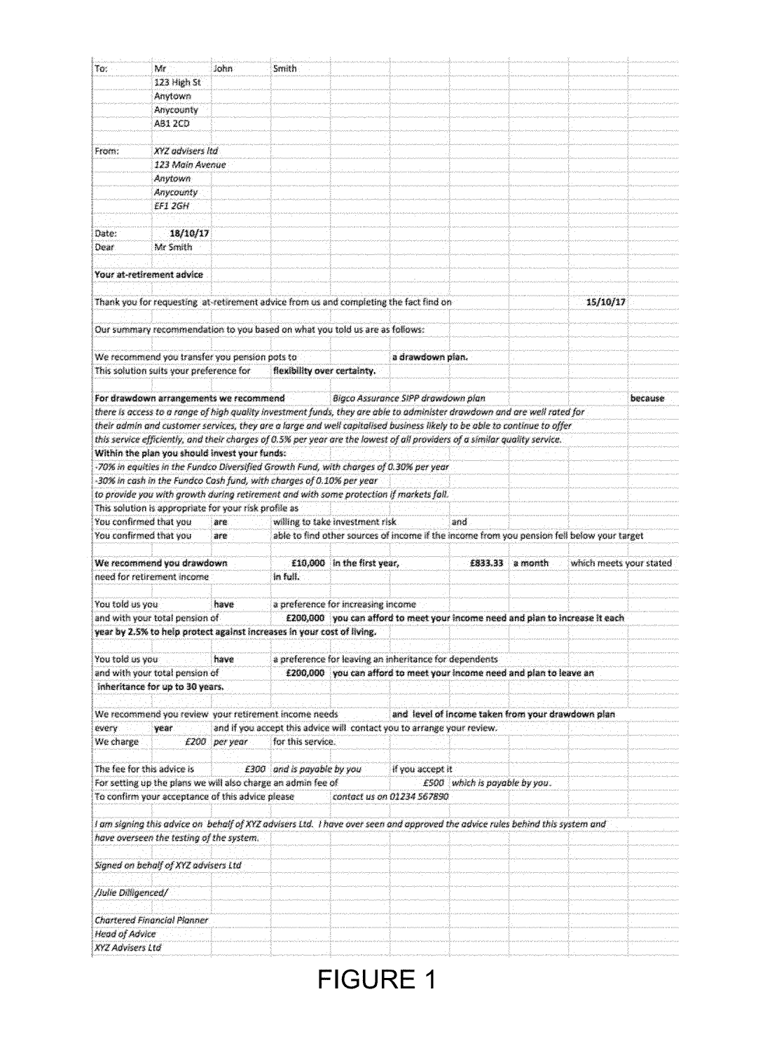

This example is shown in FIG. 1. In FIG. 1, the text in bold is Variable fields generated by the Smart Platform advice algorithms, and the text in italics is Other information supplied by advice firm displayed under conditional logic by Smart Platform.

### Test Case 1B—User Advice Example

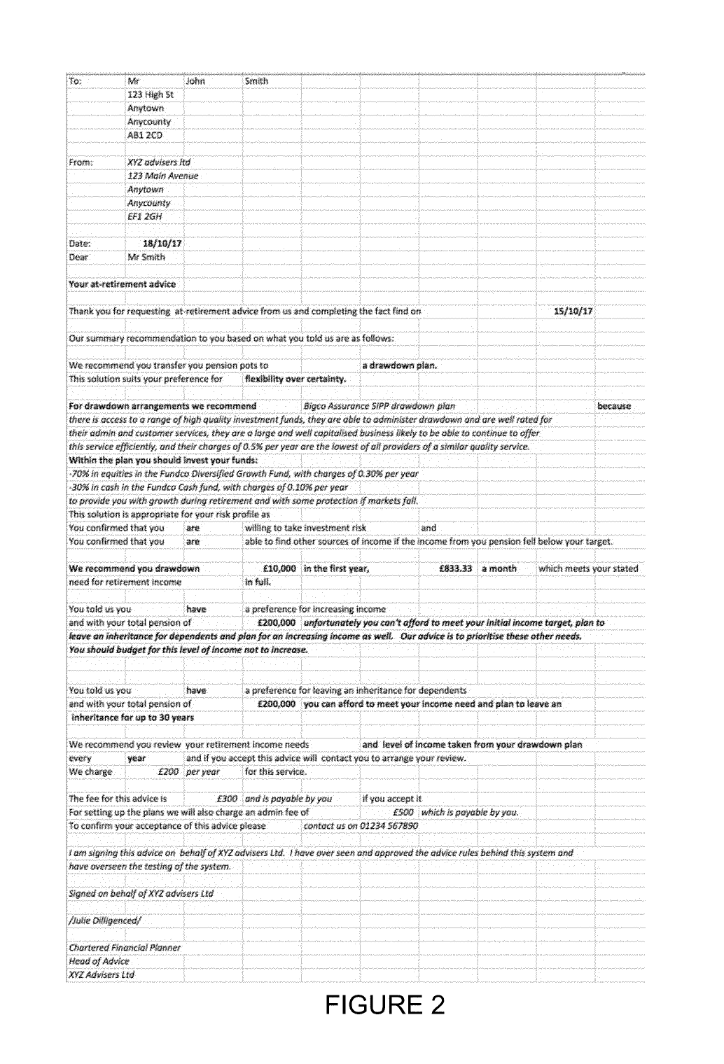

This example is shown in FIG. 2. In FIG. 2, the text in bold is Variable fields generated by the Smart Platform advice algorithms, and the text in italics is Other information supplied by advice firm displayed under conditional logic by Smart Platform. The text in bold italics is Changes vs Test Case 1A generated by Smart Platform advice algorithms. The text in bold italics may be used to verify that a set of changes to Financial Advice Rules have been implemented correctly.

### Test Case 2A—User Advice Example

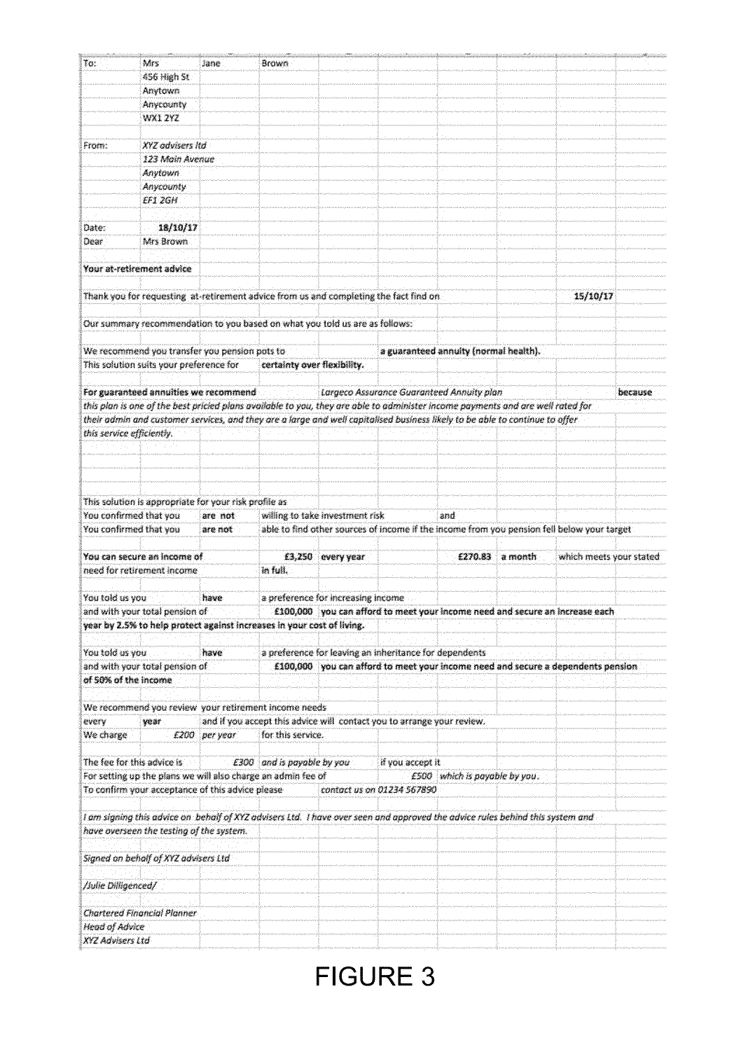

This example is shown in FIG. 3. In FIG. 3, the text in bold is Variable fields generated by the Smart Platform advice algorithms, and the text in italics is Other information supplied by advice firm displayed under conditional logic by Smart Platform.

### Hardware and Systems Examples

In an example, the Smart Platform Infrastructure stack is built from cloud components on Amazon Web Services (AWS). In this example, the system achieves resiliency and scalability through its use of clustering with Docker containers and Kubernetes scheduling. The system may be distributed across multiple zones and regions. The data tier may be a mix of Structured Query Language (SQL) and No-SQL databases, and S3 object buckets. A bucket is a logical unit of storage in Amazon Web Services (AWS) object storage service, Simple Storage Solution S3. Buckets are used to store objects, which consist of data and metadata that describes the data.

Docker is a software technology providing containers, promoted by the company Docker, Inc. Docker provides an additional layer of abstraction and automation of operating-system-level virtualization on Windows and Linux. Docker uses the resource isolation features of the Linux kernel such as cgroups and kernel namespaces, and a union-capable file system such as OverlayFS and others to allow independent “containers” to run within a single Linux instance, avoiding the overhead of starting and maintaining virtual machines (VMs).

Kubernetes is an open-source system for automating deployment, scaling and management of containerized applications that was originally designed by Google and donated to the Cloud Native Computing Foundation. It aims to provide a “platform for automating deployment, scaling, and operations of application containers across clusters of hosts”. It supports a range of container tools, including Docker.

In an example, an extensive range of security mechanisms is used, ranging from network segmentation and firewalls through to multiple levels of encryption and public key cryptography.

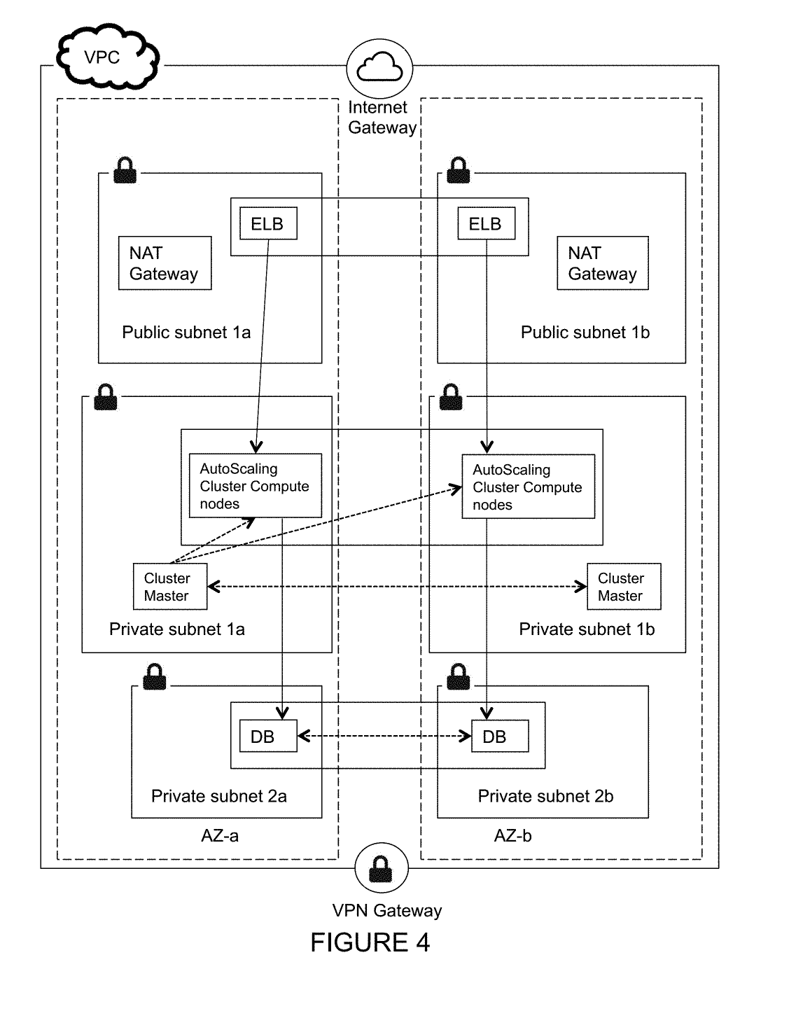

An example Smart Platform Infrastructure stack is shown in FIG. 4. In FIG. 4, ‘ELB’ stands for Elastic Load Balancing, ‘NAT’ stands for Network address translation, ‘DB’ stands for database, ‘VPC’ stands for virtual private cloud, ‘AZ’ stands for Availability Zone, and ‘VPN’ stands for virtual private network.

Wealth Wizards Smart Platform—Features and Benefits of Our Smart Platform

In an example, an important factor in the flexibility of the Smart Platform is the way it is built from a collection of distinct components. Each component can be configured to your unique requirements and is available as a free-standing service—accessible through our application programming interface (API)—or as part of a fully integrated end-to-end solution. In an example, we are using a micro-services architecture.

### The Four Main Advice Components, in an Example Implementation

The Smart Fact Find is where we collect all the customer data for a given advice journey. Hopefully we'll already have a certain amount of data—for example from a provider or from an employer—but otherwise the customer will be providing their own data, including soft facts about their attitudes and priorities. Keep in mind that the platform doesn't dictate how this data is entered; it could be via a fully digital customer journey, or it could be over the telephone or in a branch—or indeed via a combination of different channels.

The fact find data feeds through to the Solution Mapping. This is the engine at the core of the robo-advice platform and it's where our expert algorithms decide the recommended outcome. At its simplest, this could be a contributions adjustment or a straightforward risk-based portfolio but, at the other extreme, it might be a specific product recommendation—or indeed a blend of products such as a drawdown contract with proportion set aside to provide a guaranteed income. In any event, the platform can be configured to implement a ‘house view’.

Once we know the solution, we need to explain it to the customer—and that's Advice Presentation. Traditionally this comes in the form of a Suitability Letter—and the platform can produce that (in a house style)—but in a digital world we also want to present the recommendation on screen. This opens the opportunity for a more engaging explanation of the advice and, consequently, much better acceptance rates.

When the customer accepts the advice, it needs to be fulfilled. This might be an instruction to an employer—or to an investment platform—or to a product provider. An important point is that, for robo-advice at scale, the instruction will be sent digitally via an appropriate integration. That's the role of Fulfilment.

### Servicing and Governance, in an Example Implementation

These components provide you with visibility and control over your advice cases as well as the necessary assurance that your robo-advice solution is compliant and operating securely. In particular, because this is roboadvice, you'll want to be confident that the advice is always correct and that no bugs have been introduced, even though we may be making changes and improvements on an ongoing basis. Our Robotester is a unique but very important capability which enables us to run, for example, hundreds of test cases through the platform to confirm that they all generate the expected outcome. You sign-off those test cases as matching your house view and we provide a test pack before every new software release so you have permanent evidence that the release is safe.

### The Infrastructure, in an Example Implementation

In an example, our platform is hosted on state-of-the art cloud technology which is secure, highly resilient and will scale—on demand—to support any plausible amount of throughput. We have also completed integrations with customer relationship management (CRM) systems, quote engines and so on.

In an example, a Wealth Wizards Smart Platform is a sophisticated component-based architecture that can be configured and adapted to suit any plausible digital advice proposition. We can supply a complete digital journey in your house brand—or you can build it yourself using our APIs. Or you may want to just power-up your adviser back-office with a digital paraplanner service. (A paraplanner is a person or system that works with a Financial Planner or Financial Adviser and completes a number of the non-client facing tasks involved in preparing and administering a Financial Plan or Report for a client.)

Sitting between the customer and the Advice, there's Customer Experience. This is critical for a primarily digital proposition and we've invested significantly in our design capabilities and in tools and frameworks to streamline the development of great customer journeys. You can have the option to build your own front-end using our Advice APIs but keep in mind the challenges of replacing a two-way conversation with an online journey.

We don't just build solutions for strictly regulated advice journeys. We need features and tools to support engagement and ongoing services, and whilst these might utilise some of the advice features, we think of them as separate components of our overall architecture. You can think of these customer-facing components as optional—you can build them yourself to work with our APIs—but however you consume our services, you'll need the Servicing and Governance components.

### Smart Platform Technology, in an Example Implementation

Summary

In an example, our innovative Smart Platform technology can be used by companies to automate some or all of the process of giving personalised advice and/or guidance to individuals. It is comprised of a range of component modules each of which is structured as a further set of microservices.

Our Technologies or Inventions Include:
1) Smart Fact-find
2) Solution Mapping/automated advice & guidance algorithms
3) Personalised Automated Content Presentation
4) Robo-tester
5) Smart Platform as a whole.

Solutions Enabled by the Smart Platform Include:
1. Investment advice, guidance and ongoing review
2. Pension advice, guidance and ongoing review (accumulation)
3. Retirement advice, guidance and ongoing review (at-retirement and decumulation)
4. Defined Benefit Pensions transfer advice, guidance and ongoing review
5. Protection advice, guidance and ongoing review
6. Mortgage advice, guidance and ongoing review
7. Debt advice, guidance and ongoing review
8. Equity release advice, guidance and ongoing review.

How do we Add Value to Companies Offering these Services?
1. Significant operational efficiency gains through efficiently triaging individuals to the most appropriate service and channel to receive the advice and/or guidance, and the automation of processes, providing more sales capacity across existing resource.
2. Corporate control of the advice and guidance process through configurable algorithms and solution mapping driving outcomes including appropriate trapdoors out of the process.
3. Delivering further efficiencies and controls specifically in the case of regulated advice, through the enabling of corporate sign-off of client advice.
4. Risk and compliance control through enabling consistent and controlled outcomes of advice and guidance and management information including fully tracked record keeping of all interactions.
5. Increasing engagement with target customers by enabling rich personalised digital experiences integrated with other service channels if required.

Why is Smart Platform a Compelling Proposition?
Significant operational efficiency gains, with evidenced savings of at least 4-5 hours work on every pension case processed using the Smart Platform;
Supports multiple engagement channels including face to face, video, telephone, workplace, desktop, tablet and mobile;
Deliver more with less—these solutions can remove the reliance on regulated/qualified personnel to deliver the advice and/or guidance, by providing a centrally controlled, automated process to generate personalised advice and guidance, and reducing/removing the reliance on labour intensive processes generally;
Integration with existing efficient processes—Smart Platform can be deployed on a modular basis integrated with existing internal or third party systems through APIs;
Consistent client outcomes—the system will provide businesses with centralised controls and automation for a process that currently is at the risk of human inconsistencies and potential oversight or incompetence;
Better Management Information (MI)—more accurate and immediate MI about processes and clients;
Better engagement with individuals seeking the convenience and utility of digital channels—provides configurable integrated websites and apps offering efficient, mobile enabled, personalised digital solutions that hold significant appeal to this largely untapped advice and guidance market;
Better customer experience—the data gathering requests are dynamic—unnecessary questions can be avoided, and useful personal information can be delivered interactively on screen during the data gathering process, and on completion advice and/or guidance recommendations can be presented immediately whilst the customer is engaged with the process;
Enables addressing the UK's acknowledged ‘advice and savings gaps’, and similarly for other countries—by enabling lower cost and more convenient advice and guidance services.

### The Features and Benefits of Our Smart Platform, in an Example Implementation

An important part of the flexibility of the Smart Platform, in an example, is the way it is built from a collection of distinct components using a micro-services architecture. Each component can be configured to unique requirements and is available as a free-standing service—accessible through APIs—or as part of a fully integrated end-to-end solution. Thus the Smart Platform can be configured to implement the businesses ‘house view’ on personalised advice or guidance for a given scenario.

### Significant Advice and Guidance Components, in an Example Implementation

The Smart Fact Find is where we collect and/or validate all the customer data for a given advice or guidance journey. If existing information is known about the user by the business these can be prepopulated for user confirmation.

The Smart Fact Find collects customer data, including ‘soft facts’ about their attitudes and priorities. The platform allows this data to be entered directly by a customer via a fully digital customer journey, or it could be entered by an employee (for example, customer service representative, para-planner or adviser) in full or part over the telephone, video or in a branch—or indeed via a combination of different channels. The Smart Fact Find includes algorithms that enable an interactive digital journey, including conditional questions, consistency checks and playback of information for confirmation or adjustment, and alerts and trapdoors for employees to act on.

The Smart Fact Find data feeds through to the Solution Mapping. This is the engine at the core of the Smart Platform and it's where our expert algorithms determine the personalised outcome. For example, this could be an advice recommendation to adjust pension contribution levels, and/or an advice recommendation to invest pension funds in a suitable risk-based portfolio, and/or an advice recommendation to use a specific product or a blend of products such as a drawdown contract with proportion set aside to provide a guaranteed income via an annuity, and/or a personalised guidance output that explains what retirement income you are on track for and what options you have at retirement.

Once the Solution Mapping is complete, the personalised output is then passed to Advice (or guidance) Presentation. This then algorithmically determines the full content of the output, for example, charts, paragraphs and sentences with an advice report, the layout and format of that output, for example pagination, branding, colours, font type, and the medium for that output, for example locked down PDF, editable word document, on screen desktop/tablet/mobile.

Where the customer has options or recommendations presented to them, the next stage is to facilitate the Fulfilment if, for example the customer accepts the advice recommendation. The Fulfilment section will generate appropriate instructions to enable execution of appropriate solution(s). For example, instructions to an employer, and/or to an investment platform, and/or to a product provider, and/or internal systems, in the most efficient way they can be accepted, for example via an API with appropriate integration.

### Servicing and Governance, in an Example Implementation

The Servicing and Governance components provide
visibility and control over tracking customer interactions and/or employee workflow related to the advice and/or guidance;
record keeping to a standard appropriate to the provision of regulated advice;
access to evidence that any change to the system has been adequately tested;
access to Robo-tester evidence.

Our Robo-tester automates the testing and creation of evidence of testing of changes to the system to a level to support and enable a corporate sign off of advice. As well as alerting if the encoded tests within any component fails, the Robo-tester can be configured with hundreds of configurable test cases with agreed outputs that any changes to the system will be tested against and discrepancies highlighted. No release will be deployed to live until all tests are passed, and evidence all tests are passed is created and stored.

### The Infrastructure, in an Example Implementation

Our platform is hosted on state-of-the art cloud technology which is secure, highly resilient and will scale—on demand—to support any plausible amount of throughput.

The platform supports integration with third party systems and we have completed live integrations with third party CRM systems, quote engines, internal customer experience layers and others.

The Wealth Wizards Smart Platform is a sophisticated component-based architecture that can be configured and adapted to suit any advice or guidance proposition. Our modules enable sophisticated interactive digital customer experience. They also provide digital support to employees such as scripting and prompts for Customer Service Representatives, para-planners or advisers in delivering a multichannel or Face to face/video/telephone customer experience. For example we can supply a complete digital journey in a “house” brand using brand guidelines—or we can integrate to a separate customer experience layer using our APIs. Or the system can be configured to employees in the process of giving advice or guidance for example as a back-office digital para-planner service for advice.

Whether the journey is supported entirely by the Smart Platform, or integrated into internal or external systems/customer experience layer, the Serving and Governance layer will support the required level of compliance and controls, for example supporting corporate sign off of regulated advice.

### “Smart Fact Find”, in an Example Implementation

The Smart Fact Find provides personal data capture and/or confirmation in order to enable automated personal outputs against a specific requirement eg automated personal recommendations including regulated financial advice.

This is unique because it supports an omni-channel customer experience for data capture for regulated advice and guidance and captures all attitudes and preferences required to give regulated advice and guidance in a way that enables automation of the output.

There are 10 examples of data capturing interactive modules delivered as microservices. Each module captures data and in an interactive experience creates and plays back metadata that can be presented back to the customer, enabling them to confirm or amend as appropriate, and/or enables alerts and flags to be passed to employees such as customer service representatives. One example is attitude to risk module, a set of psychometric questions that map to an overall attitude to risk description. This is presented back to the customer and they can agree to it or select an alternative description, & any inconsistencies in the answers can be flagged and provide a trapdoor from the process if necessary.

### “Solution Mapping/Automated Advice Algorithms”, in an Example Implementation

The solution mapping takes client data and metadata through APIs and automates output from a range of possible outputs through APIs. This can be configured for the organisation's “House View” of advice and/or guidance.

This is unique because it automates all aspects of focussed regulated advice and guidance including appropriate product solutions, investment solutions, contribution levels, withdrawal/income levels, and protection levels, enables corporate sign off of this advice and guidance, and is agnostic on the channel for inputs (of data) and outputs (of personalised advice and/or guidance).

### “Personalised Automated Content Presentation (PACP)”, in an Example Implementation

The PACP takes variable automated output and organises and displays it using a prescribed set of formatting parameters and conditional content items.

The PACP is unique because it enables personalisation of the output—customer is getting content that is personal to him or her—sufficient to enable the corporate sign off of that advice and/or guidance. No other companies are providing services that enable this across multiple areas of focussed advice.

### “Robo-Tester”, in an Example Implementation

The Robo-tester takes sets of inputs and tests the integrity of the Smart Platform including testing the outputs in prescribed form against a set of test cases, tests all assertions of Smart Platform code, and outputs the test evidence in a suitable format for corporate compliance and governance oversight.

Robo-tester is unique in the context of generating test output suitable for the governance and compliance monitoring for multiple areas of focussed advice and/or guidance and enabling the corporate sign off of that advice and/or guidance.

### “Smart Platform”, in an Example Implementation

The Smart Platform integrates Smart Factfind, Solution mapping, PACP and Robo-tester along with 3^{rd} party record keeping/CRM/back office/payment/fulfilment systems, enabling automated personalised output including regulated advice and guidance, and related servicing and governance of those services delivered as Software As A Service (SAAS) on a modern tech infrastructure, secure login and ISO27001 data standards, modular APIs and cloud hosted.

It is the first business-to-business (B2B) regulated advice and guidance platform that enables corporate sign off of advice and guidance across multiple areas of focussed advice. Other companies, such as Parmenium, have had a simplified investment advice platform, but this invention is unique because it enables corporate sign off of advice and guidance across multiple areas of focussed advice, configurable to the corporate ‘House View’, agnostic and configurable on fulfilment solutions, and integrates with existing internal and 3^{rd} party systems. The combination is unique as a whole, but also in separate combinations.

### Detailed Analysis of “Smart Fact-Find”, in an Example Implementation

The Smart Fact-find provides personal data capture and/or confirmation in order to enable automated personal outputs against a specific requirement eg automated personal recommendations including regulated financial advice.

| Benefits & challenges of | | |
|---|---|---|
| automated advice fact | | |
| finding | Smart fact find delivers | How |
| 1. Take it at your own pace, | Able to complete 24/7 | Responsive multi- |
| no pressure (real or perceived) | through phone/tablet/PC, | device CX. |
| | save and come back. | Secure login. |
| 2. May be more likely to give | No human involvement - | Configure for client |
| honest answers to a machine | unless you want it | access to complete |
| rather than a (perceived to be) | (depending on client | questions and/or |
| judgmental person | engagement design) | adviser or customer |
| | | service agent to |
| | | complete questions |
| 3. Adviser may provide | Control around the | Content framework, |
| inappropriate framing/steers | positioning and | serving capability and |
| (consciously or subconsciously) | contextualising of all | tested content |
| | questions | |
| 4. Able to be interactive and | Grouping of questions and | Algorithms to generate |
| play information back | play back of any profiling to | meta data and select |
| | check client agrees, with | content determined by |
| | chance to override. | the answers given. |
| | | Serving capability. |
| | | Ability to override meta |
| | | data |
| 5. Structured and can't be | Journey cannot progress | Field validation. |
| completed without full info | without all fields. | |
| being provided | | |
| 6. Responsive to answers | Future questions and content | Algorithms define |
| already supplied and does not | displayed can depend on data | conditional questions |
| ask unnecessary questions | previously supplied in the | and content. |
| | journey | |
| 7. Making sure clients | Video and jargon-free | Confirmation data |
| understand the service they are | language is used to explain | capture and triage |
| receiving and the questions they | the services. Clients are | content and serving |
| are answering | regularly asked to confirm | capability. |
| | understanding during the | |
| | journey, with clear | |
| | signposting to FAQ content | |
| | and live chat/telephone/ | |
| | email contact with customer | |
| | services | |
| 8. Ensuring there are | In addition to signposting | Algorithms to create |
| appropriate “trapdoors” out of | different engagement | meta data relating to |
| an online process | options, proactive referrals | referrals out of process, |
| | out of the automated process | and serving capability |
| | if the answers indicate an | |
| | additional service or channel | |
| | is appropriate. | |
| 9. Avoiding/detecting any | Consistency checks built in | Field validation. |
| data entry errors | between questions. | Algorithms to |
| | Taking verified external data | determine data |
| | feeds where available rather | consistency between |
| | than asking client. | answers, and related |
| | | message generation if |
| | | inconsistent. Serving |
| | | capability. |
| | | API integration with |
| | | digital data sources/ |
| | | feeds and serving/ |
| | | editing capability for |
| | | client verification. |
| 10. Setting expectations on | Initial framing explaining | Content framework, |
| how long it can take and what | likely length of journey and | serving capability anc |
| information they will need to | what info they will need to | tested content |
| have to hand | find out ahead of completing | |
| | (eg statements etc) | |
| 11. Grouping the questions | Behavioural economics | Content framework, |
| appropriately so that they are | driven insight into grouping | serving capability anc |
| best able to answer them | and order of questions | tested content |
| 12. Capturing attitudes and | Interfaces enabling capturing | Interface that captures |
| preferences - turning “soft | preferences and attitudes in a | preferences as data. |
| facts” into data | way that can be processed by | Interface that captures |
| | algorithms | attitudes as data. |
| | | Algorithms to generate |
| | | meta data relating to |
| | | preferences & attitudes, |
| | | and select content |
| | | determined by the |
| | | answers given. Serving |
| | | capability. |
| | | Ability to override meta |
| | | data |
| 13. Ensuring there are no | Always signpost alternative | Content framework, |
| dead-ends to the customer | routes or communicate next | serving capability and |
| journey | steps if client not able to | tested content |
| | proceed in the digital journey | |
| | for any reason | |
| 14. Clients engaging across | Data carries across and | Input data and related |
| multiple channels | further data can be captured | meta data carried across |
| | in addition or entirely by a | user sessions and/or |
| | customer service | agent sessions and |
| | representative or adviser, | available for each new |
| | based on a face to face or | session across multiple |
| | remote engagement | devices |
| 15. Confirmation of exactly | “Statement of Fact” - full | Input data and related |
| what data was supplied when | record of data submitted - | meta data including any |
| and client confirmation | including any over-rides or | over-rides or updates |
| | updates - captured, time | captured and stored and |
| | stamped and available for the | retrievable with full |
| | client's and | audit trail and timeline. |
| | business's records | |
| 16. Different corporate | Configurable for each | Content framework, |
| requirements for data items | implementation | serving capability and |
| required from clients | | tested content. |
| | | Integrate 3^{rd} party |
| | | providers for data |
| | | gathering and meta data |
| | | creation into |
| | | framework. |
| 17. Include 3^{rd} party questions | 3^{rd} party questions integrated | Integrate with 3^{rd} party |
| and outputs | with customer journey and | suppliers of questions |
| | any output from 3^{rd} party | and meta data (eg risk |
| | captured and can be used to | profiling, medical |
| | play back content, customise | underwriting) eg via |
| | following questions, cross | API |
| | check against other data | Capture data input and |
| | | meta data received |
| | | back, algorithms define |
| | | any conditional |
| | | questions, content andc |
| | | crosschecks. |

### Detailed Analysis of “Solution Mapping/Automated Advice Algorithms”, in an Example Implementation

The solution mapping takes client data and metadata through APIs and automates output from a range of possible outputs through APIs.

| Benefits & challenges of | | |
|---|---|---|
| automating the creation of | | |
| personalised advice/ | | |
| guidance output | Solution mapping delivers | How |
| 1. Entity giving advice/ | Configures output to “house | Algorithms |
| guidance will have “house view” | view” as captured in house | configurable to deliver |
| on preferred outcomes | view questionnaire or bank | “house view” |
| | of model data inputs/outputs | Machine learning able |
| | | to learn “house view” |
| | | based on model cases |
| | | of inputs/outputs |
| 2. The solution will potentially | Optimises against the key | Runs multiple scenarios |
| need to satisfy multiple criteria | criteria whilst satisfying | each assessed against |
| some of which may be | others (or feeding back that | required satisfaction/ |
| competing | data inputs or criteria need to | optimisation of criteria |
| | be altered for a solution) | |
| 3. The advice/guidance will | Configures to the terms and | Algorithms |
| depend on the terms and | features available at the time | configurable to product/ |
| features of the range of | (eg product minima, advice | service terms and |
| potential solutions (such as | fees charged to product, | features. Integrate with |
| products and services) available | annuity rates) | external data feed for |
| at that time | | product/service terms |
| | | and features (eg third |
| | | party annuity quote |
| | | engine) |
| 4. Ease of governance and | Automatically produce | Customisable |
| fulfillment | summary of solution | algorithms determining |
| | mapping for entity's | how solution mapping |
| | governance purposes and | summarised and |
| | related fulfillment | fulfillment instructions |
| | instructions for entity's | structures |
| | processing efficiency | |

### Detailed Analysis of “Personalised Automated Content Presentation (PACP)”, in an Example Implementation

The PACP takes variable automated output and organises and displays it using a prescribed set of formatting parameters and conditional content items.

| Benefits & challenges of | | |
|---|---|---|
| automating the | | |
| production of content | | |
| personalised to the client | | |
| and customised to the | | |
| distributor | PACP delivers | How |
| 1. Entity giving advice/ | Configures output to | Customisable digital design |
| guidance will have | “house view” as captured | templates |
| “house view” on preferred | in design guidelines | Content management |
| branding/design and | and/or model format | framework with |
| format of output, and | templates | configurable/customisable |
| specific entity details it will | Configures to entity | entity details |
| want displayed | details (eg company name, | |
| | address, signatory, | |
| | customer service contacts | |
| | etc) | |
| 2. Advice/guidance | Advice/guidance may be | Customisable digital design |
| may be output or delivered | output or delivered across | templates for multiple |
| across different media or | different media or devices | output formats including |
| devices (eg pdf, onscreen | (eg pdf, onscreen Pc/in | configurable serving and |
| Pc/in app mobile) | app mobile) | layout rules for each |
| 3. Available to client, | Output to a client facing | Customisable digital design |
| adviser or both | interface or an adviser | templates for multiple |
| | facing interface. | output formats including |
| | | configurable serving and |
| | | layout rules for each |
| 4. Available locked | Output as either locked | Customisable levels of |
| down, or editable | down content (to client) | editable access to output |
| | or editable content (for | content |
| | adviser). Extent of editing | |
| | available configurable. | |
| 5. Entity giving advice/ | All content can be | Content management |
| guidance will have | customised to required | framework with library of |
| “House view” on content | wording. | content with each element |
| and tone of voice in how | | fully customisable. |
| presented | | |
| 6. Presents the | Displayed content | Library of content with each |
| appropriate solution for the | customised to the output | element selected and if |
| clients data | of the solution mapping | appropriate modified by |
| | | algorithm based on the |
| | | output from the solution |
| | | mapping |
| 7. Presents the input | Full “statement of fact” | Content management |
| data and client profiling | produced with the option | framework with |
| information on which the | to append this to the | |
| solution mapping and | displayed content | |
| displayed content is based | | |

### Detailed Analysis of “Robo-Tester”, in an Example Implementation

The Robo-tester takes sets of inputs and tests the integrity of the Smart Platform including testing the data capture, testing the outputs in prescribed form against a set of test cases, tests all assertions of Smart Platform code, and outputs the test evidence in a suitable format for corporate compliance and governance oversight.

| Benefits & | | |
|---|---|---|
| challenges of | | |
| automated testing | Robo-tester delivers | How |
| 1. Tests the data | Test all elements of data | Automation of test runs against |
| capture is as required | gathering are present | predefined criteria with error |
| | including any conditional | reporting |
| | questions, as required | |
| 2. Test the solution | Tests all assertions of the | Automation of test runs against |
| mapping output is as | solution mapping code | predefined criteria with error |
| required | | reporting |
| 3. Tests the displayed | Tests the displayed output | Automation of test runs against |
| output is as required | against range of model cases | predefined criteria with error |
| | of displayed output using the | reporting |
| | matching client data. (Model | |
| | cases selected by entity) | |
| 4. Test evidence | Evidence pack to show that | Summary data of test run |
| created as required | all tests have been run with | results for each type of test |
| | what results, run every time | output to customisable format |
| | there is a release to live. | |

### Detailed Analysis of “Smart Platform” Overall, in an Example

The Smart Platform example integrates Smart Fact-find, Solution Mapping, PACP and Robo-tester along with 3^{rd} party record keeping/CRM/back office/payment/fulfilment systems enabling automated personalised output including regulated financial advice and guidance, and related servicing and governance of those services, delivered as Software As A Service (SAAS) on a modern tech infrastructure, secure login and ISO27001 data standards, modular APIs and cloud hosted.

| Benefits & challenges | | |
|---|---|---|
| of SAAS for automated | | |
| advice and guidance | Smart Platform delivers | How |
| 1. Customisable | Brings together Smart | Integrated modular API system |
| to entity delivering | Factfind, Solution mapping, | |
| advice/guidance | PACP and Robo-tester all | |
| | customisable to entity | |
| 2. Personalised to | Brings together Smart | Integrated modular API system |
| client | Factfind, Solution mapping, | |
| | & PACP all customisable to | |
| | client | |
| 3. Appropriate | Secure login and ISO27001 | Level of encryption, ISO270001 |
| governance and | data standards, integrate with | compliance, full date and time- |
| controls including | 3^{rd} party record keeping/ | stamped presented output and |
| client data security | CRM | corresponding client data and |
| | | meta data available to store or |
| | | pass to 3rdpart record keeping |
| | | system. |
| 4. Integrates with | Integrates with record | Integrates with APIs. |
| existing or required | keeping/CRM/back office/ | |
| third party systems | payment/fulfilment | |
| | systems | |

Live Services

The Smart Platform may support the following live services:
Focussed investment advice, guidance and ongoing review (as part of Wealth Wizards Pension Wizard Service);
Pension advice, guidance and ongoing review (accumulation) (as part of Wealth Wizards Pension Wizard Service);
Retirement advice, guidance and ongoing review (at-retirement and decumulation) (as part of LV=Retirement Wizard Service—direct to consumer, and as part of the Retirement Wizard Robo-Paraplanner used by LV=employees).

### Prototypes Examples

Prototype/proof of concept versions of smart fact find, solution mapping and personalised presentation have been developed for:
Defined Benefit Pensions transfer advice, guidance and ongoing review;
Protection advice, guidance and ongoing review (as part of Protection Wizard);
Equity release advice, guidance and ongoing review (as part of Equity Release Wizard);
Holistic financial priorities guidance and ongoing review (as part of Money Wizard).

Versions may be provided for:
Mortgage advice, guidance and ongoing review;
Debt advice, guidance and ongoing review;
Holistic financial priorities advice.

In examples, the artificial intelligence capabilities of all aspects of the Smart Platform including enhanced machine learnings, data mining and voice/text recognition may be enhanced. In examples, a machine learning approach is used for solution mapping.

The Smart Platform capabilities are proven to support multiple areas of focussed regulated financial advice and/or guidance, and are extended to all areas where focussed regulated financial advice and/or guidance is or can be offered. It is also extendible into other applications of regulated or unregulated advice and/or guidance, with insurance, banking, legal, compliance, and accountancy as examples.

### Smart Platform Overview Examples

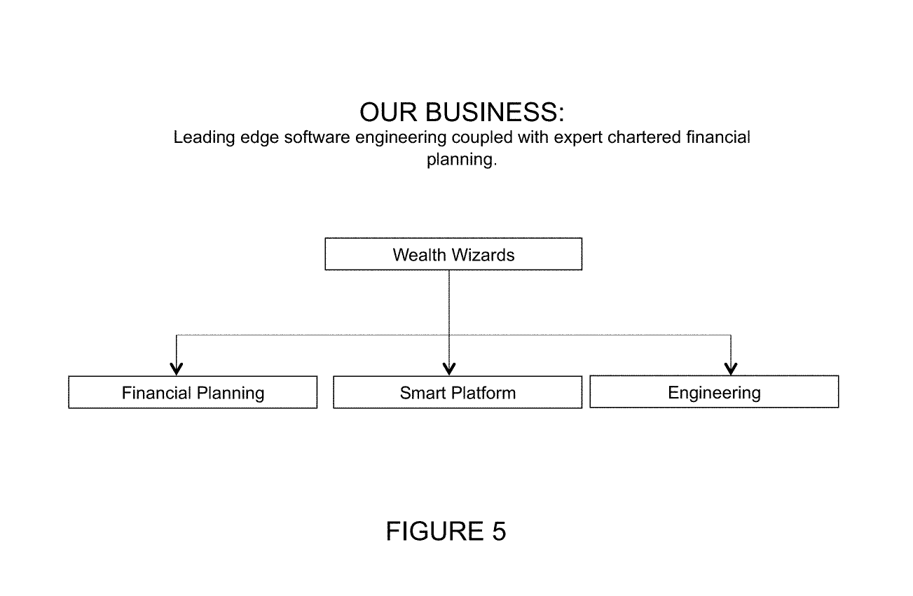

FIG. 5 shows an overview of the business of Wealth Wizards.

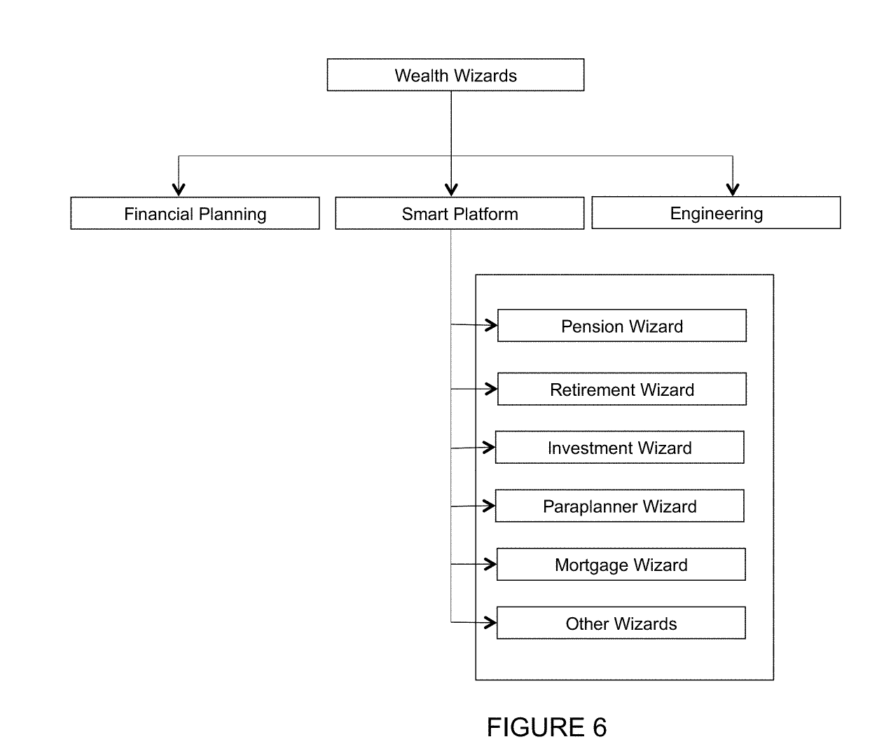

FIG. 6 shows examples of financial products which sit on an example of the Wealth Wizards Smart Platform.

Financial ignorance is rife in the UK. 4 in 5 people have no idea how they will fund retirement. 2 in 3 financial products are bought without advice. 1 in 5 people cannot read a bank statement. 16 Million adults in advice gap. Similar problems may exist in other countries.

Robo-advisors or Robo-advisers are a class of financial adviser that provide financial advice or portfolio management online with moderate to minimal human intervention. They provide digital financial advice based on mathematical rules or algorithms. These algorithms are executed by software and thus financial advice does not require a human advisor. The software utilizes its algorithms to automatically allocate, manage and optimize clients' assets.

Regarding Roboadvice, technology is enabling greater customer engagement and more transactions. It is cost-effective. It is helping people feel in control and get financially sorted.

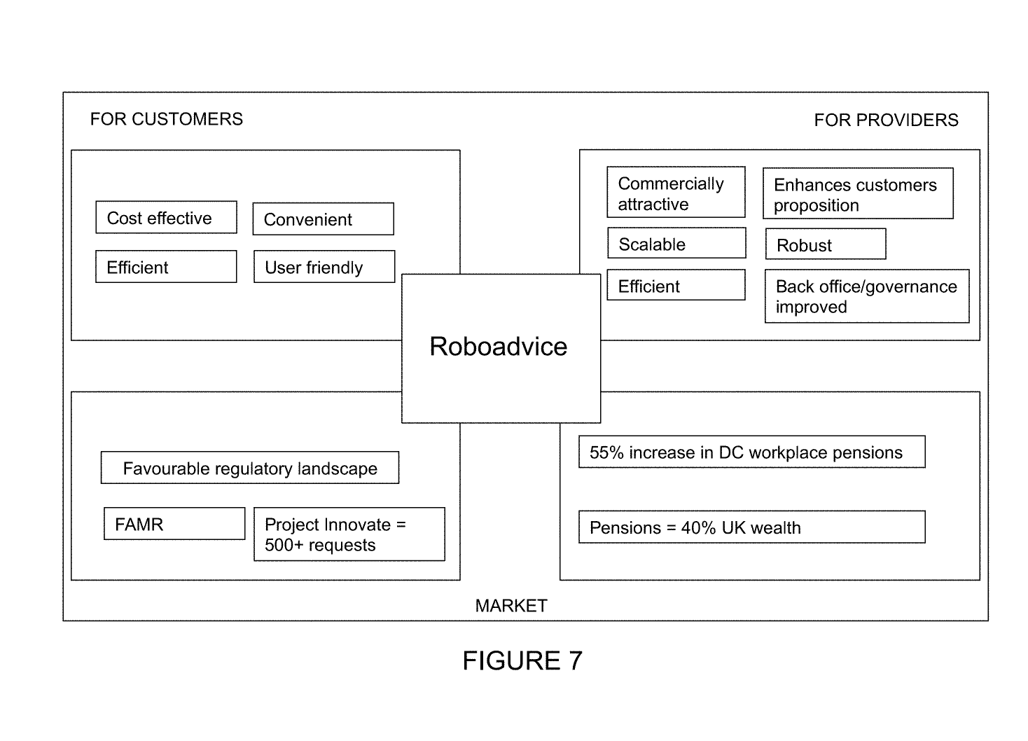

FIG. 7 shows how Roboadvice may sit between customers, providers and the Market.

An example of the Smart Platform is a leading edge smart platform to deliver roboadvice. It typically includes: State of the art software engineering; Compatible with existing investment, CRM or compliance systems; Bespoke to you with multiple customisation options; Pick and mix microservice architecture; Fully secure with guiding principles taken from ISO27001 and PCI/DSS (Payment Card Industry Data Security Standard) standards.

In an example, the platform provides automated financial advice. In Engagement & Ongoing Services it may provide Income Planning, Expenditure Planning, Statements & Valuations and Tools & Calculators.

In an example, in Advice, the platform provides Smart Fact Find, Solution Mapping, Advice Presentation and Fulfilment.

Smart Fact Find may include: “Know your customer”; Soft facts (attitudes & priorities) distilled to profile scores; Understanding tested & confirmed; Hard facts distilled to profile scores; Goal(s) established; Advice objective tested & confirmed (advice). A Strategic objective may be gamification and replacement of self-service data entry with live intelligence from customer-agreed sources, e.g. employer data, personal finance aggregation, Open Banking, Pensions Dashboard, biometrics, social networks, etc.

Solution Mapping may include: Input: scored customer profile from Smart Fact Find; Expert algorithm combining profile scores and solution mapping rules; Output: Suitable advice outcome e.g. “Drawdown contract at risk level 5 paying an income of x”; Referral(s) identified for human intervention; Compliance record generated. A strategic objective may be: Maximise automation (minimise referrals). Seek opportunities for use of Big Data and machine learning within the algorithms.

Advice Presentation may include: Input: suitable advice outcome from Expert Algorithm; Explanation and illustration of advice outcome, including Reason for advice (including options considered), Investment product details, Scope of advice, Risk explanation/illustration; Content generated for flexible on-screen presentation; summary, detailed and graphical; Suitability letter generated. A strategic objective may be: evidence “treat customer fairly” and “good customer outcome” as appropriate for a digital customer experience.

Fulfilment may include: implementation of accepted advice e.g.
Buy/Sell/Switch instruction to investment platform;
Buy investment/protection policy;
Employer instruction (contribution %, salary exchange).

A strategic objective may be: zero manual intervention at adviser business and at product provider/employer.

Smart Fact Find may include reusable components, which offer build efficiency. Reusable components may include the following microservices: Attitude to Risk, State Pension Age, Financial Resilience, Target Retirement Income, Financial Flexibility.

Advice Presentation may include: Risk Illustration, Product Description, Product Illustration, Advice Signatory, Content Builder.

The Smart Platform may extend to other products, as shown for example in FIG. 6.

In an Automated Advice Framework, Algorithms may
Define profile scoring for each relevant dimension.
Define decision scoring for whole advice profile.
Describe solution/product mapping to decision scoring.
Calibrate range of investment outcomes calculation.
Identify triggers for human intervention.

In an Automated Advice Framework, Interactivity may
Produce profile descriptions for each relevant dimension.
Define display of investment outcome illustrations.
Specify risk illustration.
Produce wording for online alerts.
Script human intervention.

In an Automated Advice Framework, Advice delivery may
Advice suitability report template.
Recommendations matrix mapped to scoring.
Ongoing review recommendation services.

In an Automated Advice Framework, Governance & oversight may provide
Management information;
Investment committee;
Risk & compliance committee.

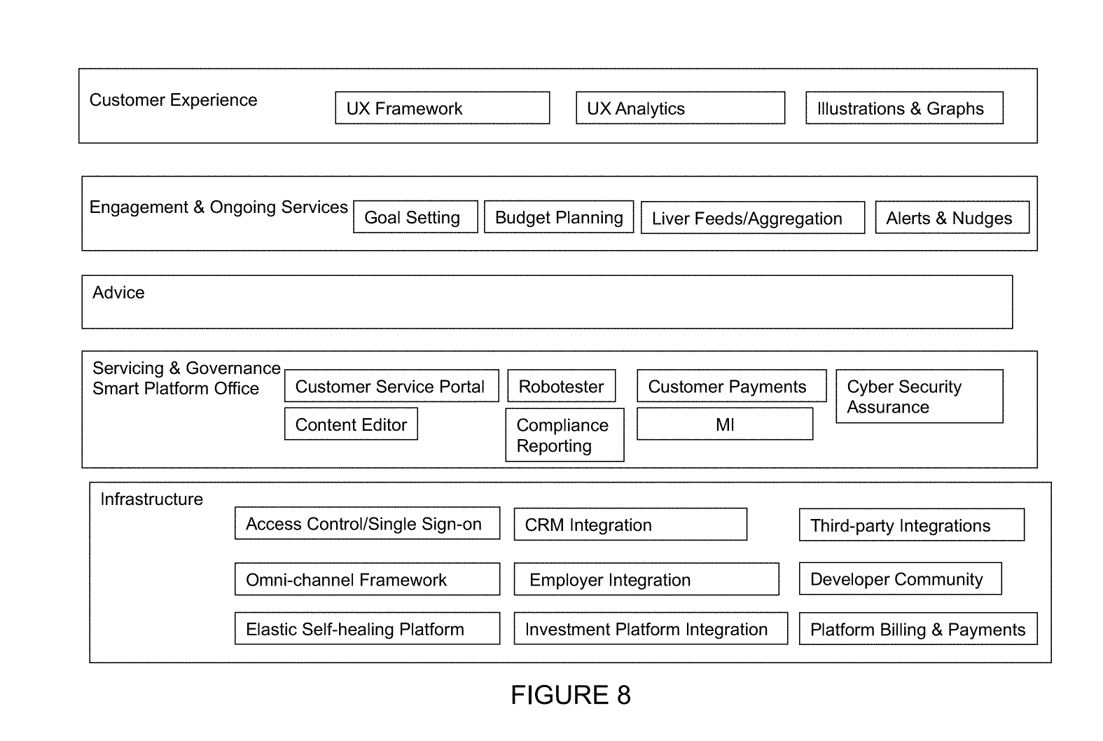

FIG. 8 shows an example of a platform architecture.

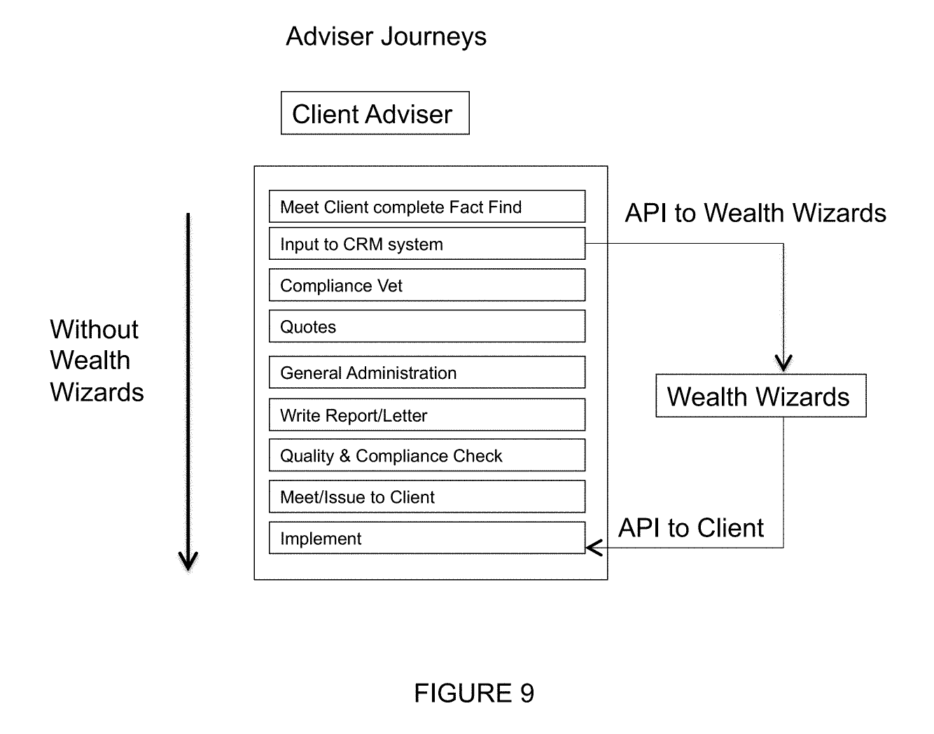

FIG. 9 shows two example Adviser Journeys, (i) using Wealth Wizards' technology and (ii) without using Wealth Wizards' technology. Use of Wealth Wizards' technology therefore avoids many cumbersome, separate tasks.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A server system for providing financial advice, wherein the financial advice satisfies a corporate certification standard, the server system including a processor, the server system being one in which:
(i) the system is configured to receive a set of financial advice rules, and to receive changes to the set of financial advice rules, such as changes in taxation rules, to produce a set of updated financial advice rules;
(ii) the system is configured to include a set of test cases;
(iii) the system is configured to run the test cases using the set of updated financial advice rules to produce a set of test case results, to test that the updated financial advice rules have been correctly implemented, and to output the set of test case results, in which the outputted set of test case results is suitable for corporate compliance and governance oversight;
(iv) the system is configured to receive a confirmation in respect of the outputted set of test case results which indicates that the outputted set of test case results complies with a corporate certification standard;
(v) the system is configured to output financial advice questions, and to receive user input in response to the financial advice questions;
(vi) the system is configured to use the corporate certification standard-approved set of updated financial advice rules, approved in part (iv), to generate responses to the user input which was received in response to the financial advice questions, and
(vii) the system is configured to output the responses to the user input which was received in response to the financial advice questions.

2. The server system of claim 1, wherein the system is configured to store the set of financial advice rules, and to store the set of updated financial advice rules.

3. The server system of claim 1, wherein the system is configured to store the set of test cases.

4. The server system of claim 1, wherein the system is configured to store the set of test case results.

5. The server system of claim 1, wherein the system is configured to provide a stored set of test case results, in response to a request for the stored set of test case results.

6. The server system of claim 1, wherein the system is configured to store the confirmation which indicates that the outputted set of test case results complies with a corporate certification standard.

7. The server system of claim 1, wherein the system is configured to provide a stored confirmation which indicates that the outputted set of test case results complies with a corporate certification standard, in response to a request for the stored confirmation which indicates that the outputted set of test case results complies with a corporate certification standard.

8. The server system of claim 1, wherein the system is configured to receive and to store the financial advice questions.

9. The server system of claim 1, wherein the system is configured to store the received user input in response to the financial advice questions.

10. The server system of claim 1, wherein the system is configured to store the generated responses to the user input which was received in response to the financial advice questions.

11. The server system of claim 1, wherein the system is configured to store the outputted responses to the user input which was received in response to the financial advice questions.

12. The server system of claim 1, wherein the output responses to the user input is in the form of a communication to the user.

13. The server system of claim 12, wherein the communication is a letter-like communication.

14. The server system of claim 12, wherein the communication is to a smart phone, a tablet computer, a laptop computer, a desktop computer, or to a TV computer, or wherein the communication is a letter-like communication and the communication is to a smart phone, a tablet computer, a laptop computer, a desktop computer, or to a TV computer.

15. The server system of claim 1, wherein the system includes servicing and governance components.

16. The server system of claim 15, wherein the servicing and governance components provide visibility and control over tracking customer interactions and/or employee workflow related to the financial advice.

17. The server system of claim 15, wherein the servicing and governance components provide record keeping to a standard appropriate to the provision of regulated financial advice.

18. The server system of claim 15, wherein the servicing and governance components provide access to evidence that any change to the system has been adequately tested.

19. The server system of claim 15, wherein the servicing and governance components provide access to Robo-tester evidence.

20. The server system of claim 1, wherein the financial advice includes one or more of: pension advice, retirement advice, investment advice, paraplanner output, defined benefit pensions transfer advice, protection advice, debt advice, equity release advice or mortgage advice.

21. The server system of claim 1, wherein the server is a single server in a single location, a group of servers in a single location, a group of servers over multiple locations, a virtual server over many locations, or a virtual server in the Cloud.

22. The server system of claims 1 to 20, wherein the server system is distributed across multiple zones and regions.

23. The server system of claim 1, wherein the server system includes an internet gateway and a virtual private network gateway.

24. The server system of claim 1, wherein the server system achieves resiliency and scalability through its use of clustering with Docker containers and Kubernetes scheduling.

25. The server system of claim 1, the server storing data, wherein the data stored on the server is in a mix of Structured Query Language (SQL) and No-SQL databases, and S3 object buckets.

26. The server system of claim 1, wherein the server system includes a range of security mechanisms including one or more of: network segmentation, firewalls, multiple levels of encryption and public key cryptography; or wherein the server system includes a micro-services architecture; or wherein the server system is integrate-able with existing internal or third party systems through APIs.

27-28. (canceled)

29. A computer-implemented method for providing regulatory-compliant financial advice, wherein the financial advice satisfies a corporate certification standard, the method including the steps of:
(i) receiving a set of financial advice rules, and receiving changes to the set of financial advice rules, such as changes in taxation rules, to produce a set of updated financial advice rules;
(ii) accessing a set of test cases;
(iii) running the test cases using the set of updated financial advice rules to produce a set of test case results, to test that the updated financial advice rules have been correctly implemented, and outputting the set of test case results, in which the outputted set of test case results is suitable for corporate compliance and governance oversight;
(iv) receiving a confirmation in respect of the outputted set of test case results which indicates that the outputted set of test case results complies with a corporate certification standard;
(v) outputting financial advice questions, and receiving user input in response to the financial advice questions;
(vi) using the corporate certification standard-approved set of updated financial advice rules, approved in step (iv), to generate responses to the user input which was received in response to the financial advice questions, and
(vii) outputting the responses to the user input which was received in response to the financial advice questions.

30. (canceled)

31. A computer program product for providing regulatory-compliant financial advice, wherein the financial advice satisfies a corporate certification standard, the computer program product executable on a processor to:
(i) receive a set of financial advice rules, and to receive changes to the set of financial advice rules, such as changes in taxation rules, to produce a set of updated financial advice rules;
(ii) access a set of test cases;
(iii) run the test cases using the set of updated financial advice rules to produce a set of test case results, to test that the updated financial advice rules have been correctly implemented, and to output the set of test case results, in which the outputted set of test case results is suitable for corporate compliance and governance oversight;
(iv) receive a confirmation in respect of the outputted set of test case results which indicates that the outputted set of test case results complies with a corporate certification standard;
(v) output financial advice questions, and receive user input in response to the financial advice questions;
(vi) use the corporate certification standard-approved set of updated financial advice rules, approved in part (iv), to generate responses to the user input which was received in response to the financial advice questions, and
(vii) output the responses to the user input which was received in response to the financial advice questions.

32-33. (canceled)
